(19) United States
(12) Patent Application Publication
(10) Pub. No.: US 2018/0210678 A1
(43) Pub. Date: Jul. 26, 2018

(54) DISPLAY INPUT DEVICE AND IMAGE FORMING DEVICE

(71) Applicant: KYOCERA Document Solutions Inc., Osaka (JP)

(72) Inventor: Takanori MIYAMOTO, Osaka (JP)

(73) Assignee: KYOCERA Document Solutions Inc., Osaka (JP)

(21) Appl. No.: 15/877,498

(22) Filed: Jan. 23, 2018

(30) Foreign Application Priority Data
Jan. 26, 2017 (JP) 2017-012495

(51) Int. Cl. G06F 3/12; G06F 3/041; G06F 3/0488

(52) U.S. Cl. CPC G06F 3/1201; G06F 3/0488; G06F 3/0412

(57) ABSTRACT

A display input device includes a display unit, a display control section, a touch panel, a message control section, and a determination section. When there is a notification item to notify a user during processing of an image forming device, the message control section instructs the display control section on contents of a message. The determination section determines whether a predetermined event has occurred. When the determination section determines that the predetermined event has occurred, the display control section changes a transmittance of a pop-up display.

### INCORPORATION BY REFERENCE

This application claims priority to Japanese Patent Application No. 2017-012495 filed on Jan. 26, 2017, the entire contents of which are incorporated by reference herein.

### BACKGROUND

The present disclosure relates to a display input device configured to display an operation screen, a message, and the like for a user and receive an operation instruction, and to an image forming device including the display input device.

The display input device included in the image forming device generally has a touch panel function, and displays an operation status of the device, a soft button for receiving an operation instruction from a user, various messages, and the like.

In the display input device, for each of the various messages, a position of a display area is predetermined in a display screen and is always fixed. However, in recent years, image forming devices have been given more functions and additionally a plurality of tasks have come to be operated at the same time in many cases, contents displayed on the display input device have become complicated, and an amount of information has increased. In such circumstances, when a fixed region for message display is always present in the display area of the display input device, it is not possible to utilize the display area effectively.

For example, as a general first method, there is a method in which a message is displayed as a banner. In addition, as a general second method, there is a method in which, when a main body of a device is in a locked state, if a change in state such as mail reception occurs, a notification icon is displayed on a lock screen.

### SUMMARY

As an aspect of the present disclosure, a technology obtained by improving the above technology further is proposed.

A display input device according to an aspect of the present disclosure includes a display unit, a touch panel, and a control unit. The touch panel is disposed on the display unit and is configured to receive a press input on a soft button displayed on a display screen of the display unit. The control unit includes a processor and, when the processor executes a control program, functions as a display control section, a message control section, a determination section. The display control section controls a display of the display screen to be displayed on the display unit. The message control section controls whether to display a message on the display unit. The determination section determines whether a predetermined event occurred. Upon receiving a message display instruction from the message control section in a state of allowing the display unit to display the display screen, the display control section allows the display unit to display, as a pop-up display, the message whose display was instructed, at a predetermined pop-up display position in a display region of the display screen. The touch panel receives the press input to the soft button even while the message is displayed as the pop-up by the display control section. When the determination section determines that the predetermined event has occurred, the display control section changes a transmittance of the pop-up display.

An image forming device according to another aspect of the present disclosure includes the above-described display input device and an image forming unit configured to form an image on a recording medium.

### BRIEF DESCRIPTION OF THE DRAWINGS

FIG. 1 is a schematic diagram showing an image forming device according to an embodiment of the present disclosure.

FIG. 2 is a functional block diagram showing a main internal configuration of the image forming device according to the embodiment of the present disclosure.

FIG. 3 is a flowchart showing a basic process in a pop-up display process performed by the image forming device according to the embodiment of the present disclosure.

FIG. 4 is a diagram showing an example of a display screen.

FIG. 5A is a diagram showing an example of the display screen.

FIG. 5B is a diagram showing an example of the display screen.

FIG. 6A is a diagram showing an example of the display screen.

FIG. 6B is a diagram showing an example of the display screen.

FIG. 7A is a flowchart showing a process when an event occurs in the pop-up display process performed by the image forming device according to the embodiment of the present disclosure.

FIG. 7B is a timing chart showing an example of changing a transmittance in the pop-up display process performed by the image forming device according to the embodiment of the present disclosure.

FIG. 8A is a flowchart showing a specific example of a process in which the event occurs in the pop-up display process performed by the image forming device according to the embodiment of the present disclosure.

FIG. 8B is a timing chart showing an example of changing the transmittance in the pop-up display process performed by the image forming device according to the embodiment of the present disclosure.

FIG. 9A is a flowchart showing a specific example of a process in which the event occurs in the pop-up display process performed by the image forming device according to the embodiment of the present disclosure.

FIG. 9B is a timing chart showing an example of changing the transmittance in the pop-up display process performed by the image forming device according to the embodiment of the present disclosure.

FIG. 10A is a flowchart showing a specific example of a process in which the event occurs in the pop-up display process performed by the image forming device according to the embodiment of the present disclosure.

FIG. 10B is a timing chart showing an example of changing the transmittance in the pop-up display process performed by the image forming device according to the embodiment of the present disclosure.

FIG. 11A is a flowchart showing a specific example of a process in which the event occurs in the pop-up display process performed by the image forming device according to the embodiment of the present disclosure.

FIG. 11B is a timing chart showing an example of changing the transmittance in the pop-up display process performed by the image forming device according to the embodiment of the present disclosure.

FIG. 12A is a diagram showing an example of the display screen.

FIG. 12B is a diagram showing an example of the display screen.

FIG. 13A is a flowchart showing a specific example of a process in which the event occurs in the pop-up display process performed by the image forming device according to the embodiment of the present disclosure.

FIG. 13B is a timing chart showing an example of changing the transmittance in the pop-up display process performed by the image forming device according to the embodiment of the present disclosure.

FIG. 14A is a diagram showing an example of the display screen.

FIG. 14B is a diagram showing an example of the display screen.

FIG. 15A is a flowchart showing a specific example of a process in which the event occurs in the pop-up display process performed by the image forming device according to the embodiment of the present disclosure.

FIG. 15B is a timing chart showing an example of changing the transmittance in the pop-up display process performed by the image forming device according to the embodiment of the present disclosure.

FIG. 16A is a diagram showing an example of the display screen.

FIG. 16B is a diagram showing an example of the display screen.

### DETAILED DESCRIPTION

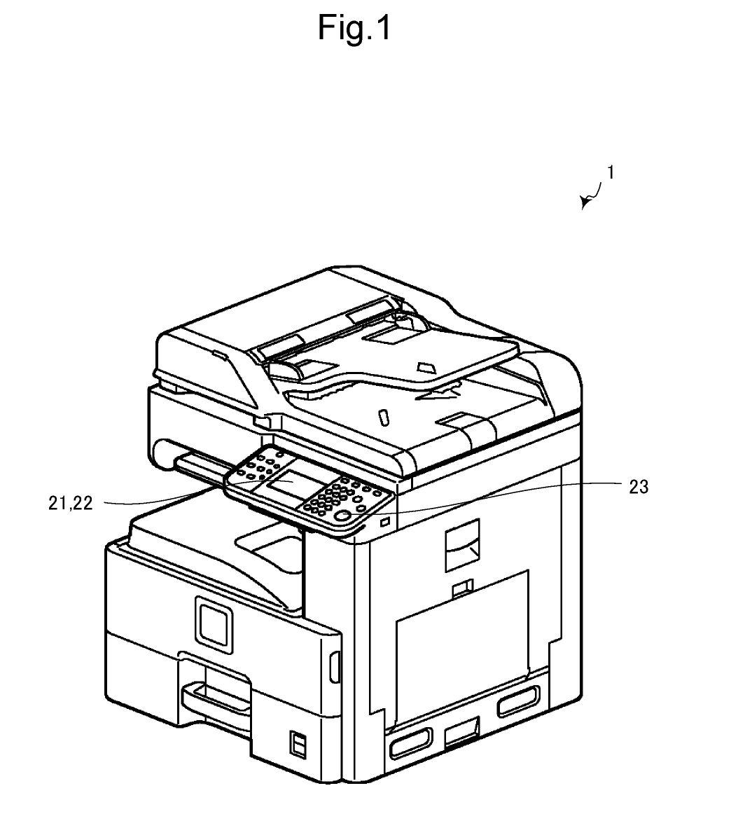

A display input device and an image forming device according to embodiments of the present disclosure will be described below with reference to the drawings. FIG. 1 is a schematic diagram showing an image forming device 1 according to an embodiment of the present disclosure.

The image forming device 1 according to the present embodiment includes an electrophotographic image forming device using a toner as a developer, an ink jet printer using an ink, and the like. A display unit 21 and a touch panel 22 that are integrally formed are provided on a front surface of a main body.

The display unit 21 is a display screen that includes a liquid crystal display (LCD) and displays an operation method, various messages, operation buttons (soft buttons), and the like. The display unit 21 and the touch panel 22 are integrally formed. The touch panel 22 is a touch panel using, for example, a resistance film method, detects a position (coordinates) at which a user performs pressing and outputs the detected position to a control unit 11 to be described below. The control unit 11 identifies a press position on the basis of position information output from the touch panel 22 and performs a process.

In addition, in the vicinity of the display unit 21 and the touch panel 22, operation hard buttons such as a start button 23, a power button, a stop and clear button, and numerical value input buttons (numeric keypad) are provided. When such operation buttons are pressed by the user, they receive instructions from the user. For example, for various operations such as copy and scan (read), the start button 23 receives a press input for operation start from the user.

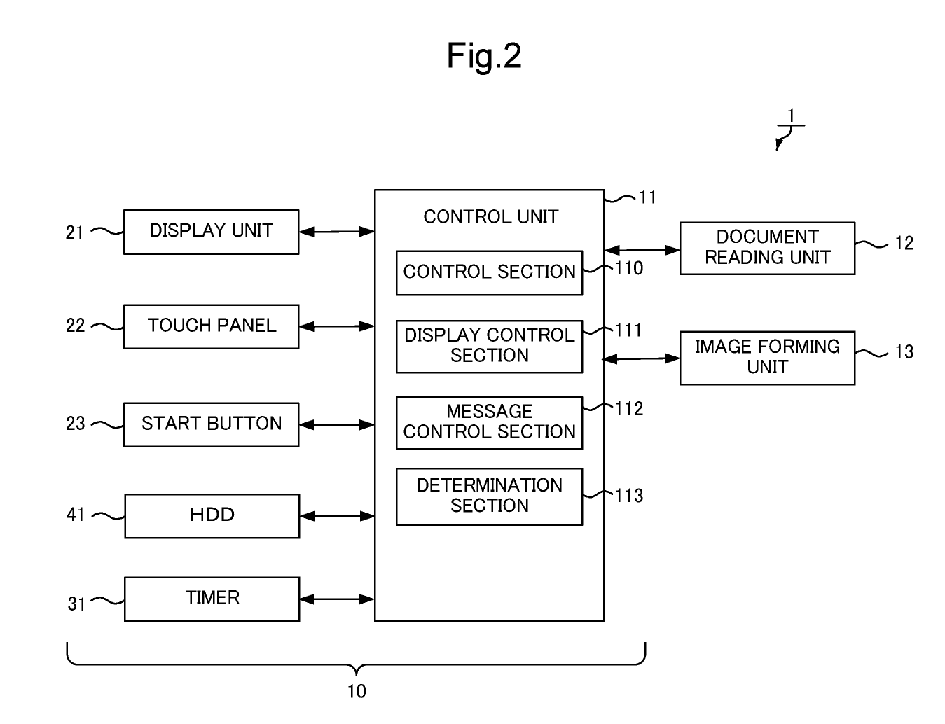

FIG. 2 is a functional block diagram showing a main internal configuration of the image forming device 1 according to the embodiment of the present disclosure. The image forming device 1 includes the control unit 11, the display unit 21, the touch panel 22, a document reading unit 12, an HDD 41, an image forming unit 13, a timer 31, and the like.

The document reading unit 12 reads an original image and acquires image data. The image forming unit 13 prints an image on paper on the basis of the image data acquired by the document reading unit 12 or image data transmitted from an external device.

The control unit 11 includes a processor, a RAM, a ROM, a dedicated hardware circuit, and the like. The processor is, for example, a central processing unit (CPU), a micro processing unit (MPU), an application specific integrated circuit (ASIC), and the like. The control unit 11 includes a control section 110, a display control section 111, a message control section 112, and a determination section 113.

The control unit 11 functions as the control section 110, the display control section 111, the message control section 112, and the determination section 113 by an operation of the processor according to a control program installed in the HDD 41. However, these units can be formed by hardware circuits independently of an operation according to a control program of the control unit 11. This similarly applies to all the embodiments unless otherwise mentioned.

The control section 110 controls overall operations of the image forming device 1.

The display control section 111 controls display of a display screen that is displayed on the display unit 21. In addition, upon receiving a message display instruction from the message control section 112 in a state of allowing the display unit 21 to display the display screen, the display control section 111 allows the display unit 21 to display, as a pop-up display, the message whose display was instructed, at a predetermined pop-up display position in a display region of the display screen. In addition, when the determination section 113 determines that a predetermined event has occurred, the display control section 111 changes a transmittance of the pop-up display (that is, a transmittance of a background color of the pop-up in the pop-up display).

The message control section 112 controls whether a message is displayed on the display unit 21. For example, when there is a notification item regarding an operation of the image forming device 1 for the user, the message control section 112 instructs the display control section 111 on contents of a message corresponding to the notification item.

In addition, when it is determined that a notification condition of the message instructed for the display control section 111 is released, the message control section 112 instructs the display control section 111 to end the pop-up display of the message. In addition, when the pop-up display is performed on the display screen of the display unit 21, if the message control section 112 determines that a notification condition of a message in the pop-up display is released, the display control section 111 allows the display unit 21 to end the pop-up display before an end time to be described below has passed on the basis of the instruction from the message control section 112.

For example, when the display control section 111 is allowing the display unit 21 to pop-up display a message of “a cover of the document reading unit 12 is open” on a display screen 90 of the display unit 21, if the user performs an operation of closing the cover of the document reading unit 12, the message control section 112 determines that a notification condition of the message in the pop-up display is released. Then, the message control section 112 instructs the display control section 111 to end the pop-up display of the message. That is, the message control section 112 instructs the display control section 111 to end the pop-up display when it is determined that there is no need to provide notification of the message (the release of the notification condition) due to the operation by the user. Then, the display control section 111 allows the display unit 21 to end the pop-up display of the message on the basis of the instruction from the message control section 112.

The determination section 113 determines whether a predetermined event has occurred. Subsequently, the event to be determined by the determination section 113 is an example of the predetermined event.

Here, the predetermined event is an event serving as a reference for changing a transmittance of a background color of the pop-up in the pop-up display on the display unit 21, and includes, for example, elapse of a predetermined specified time from a predetermined time (time-elapse event), a predetermined operation being performed by a user on the image forming device 1 such as button pressing (user event), the occurrence of a predetermined function in the image forming device 1 (system occurrence event), and the like (details will be described below). In addition, contents of the predetermined event are stored (set) in the HDD 41 in advance, for example, when an administrator of the image forming device 1 operates an operation unit (not shown). Then, when the determination section 113 determines that such a predetermined event has occurred, it notifies the occurrence of the event to the display control section 111.

The timer 31 measures time. For example, when the display control section 111 allows the display unit 21 to perform the pop-up display, the timer 31 measures a time elapsed from a time at which the pop-up display starts. In addition, when the message displayed in the pop-up is a long sentence message, the timer 31 sets a time at which the entire long sentence message has been displayed in the pop-up as a time at which the pop-up display starts, and measures a time elapsed from that time. In addition, when the display control section 111 changes a transmittance of the pop-up display, the timer 31 resets a count value from the time at which the pop-up display starts, and measures a time elapsed from the time at which the display control section 111 changes the transmittance. In addition, when the display control section 111 allowed the display unit 21 to end the pop-up display, the timer 31 stops measuring the elapsed time.

In addition, a display input device 10 of the image forming device 1 includes the display unit 21, the touch panel 22, the start button 23, the timer 31, and the control unit 11 (in particular, the display control section 111, the message control section 112, and the determination section 113).

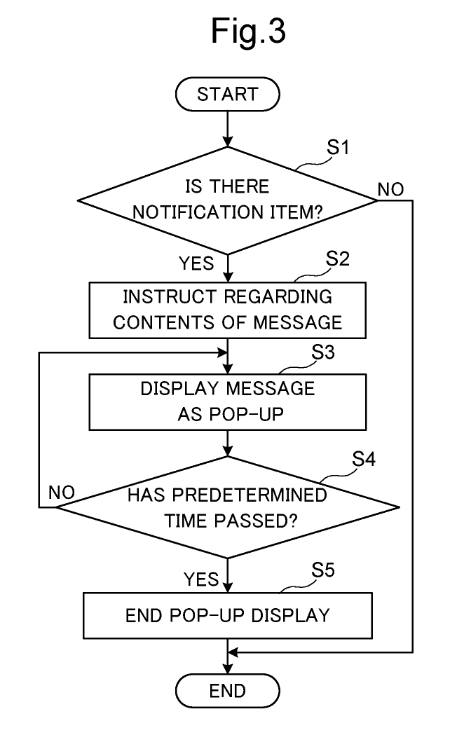

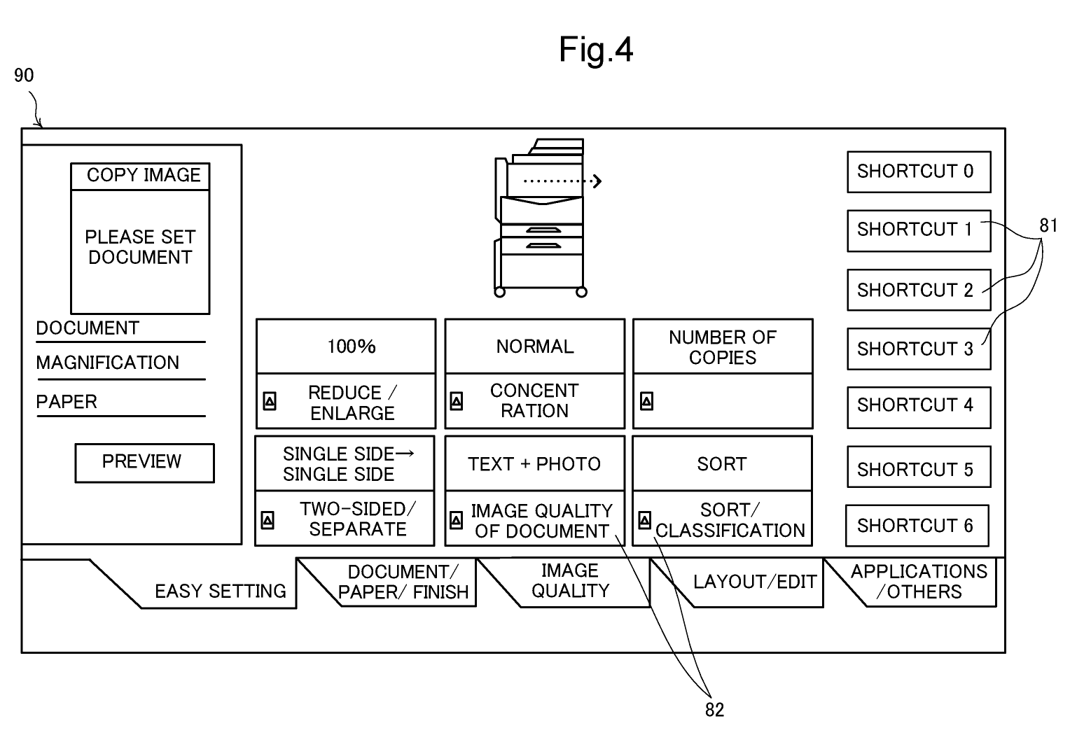

Next, a pop-up display process performed by the image forming device 1 will be described. First, a basic process in the pop-up display process will be described with reference to FIG. 3 to FIG. 6B. FIG. 3 is a flowchart showing a basic process in the pop-up display process performed by the image forming device according to the embodiment of the present disclosure. FIG. 4 to FIG. 6B are diagrams each showing an example of the display screen 90 that is displayed on the display unit 21 by the display control section 111.

In a general image forming device, in order to display a new message whose display is required within the display screen, a fixed region in which none of information is displayed is provided in advance. That is, the fixed region is a region in which a message is displayed only when display is necessary and nothing is displayed when display is not necessary.

However, in the image forming device 1 of the present embodiment, the fixed region is not provided in the display screen 90 of the display unit 21. When the fixed region is removed, the image forming device 1 can display some information on the entire display screen 90 that can be displayed on the display region of the display unit 21 irrespective of whether a message is displayed. Accordingly, it is possible to effectively use the entire display region of the display screen 90.

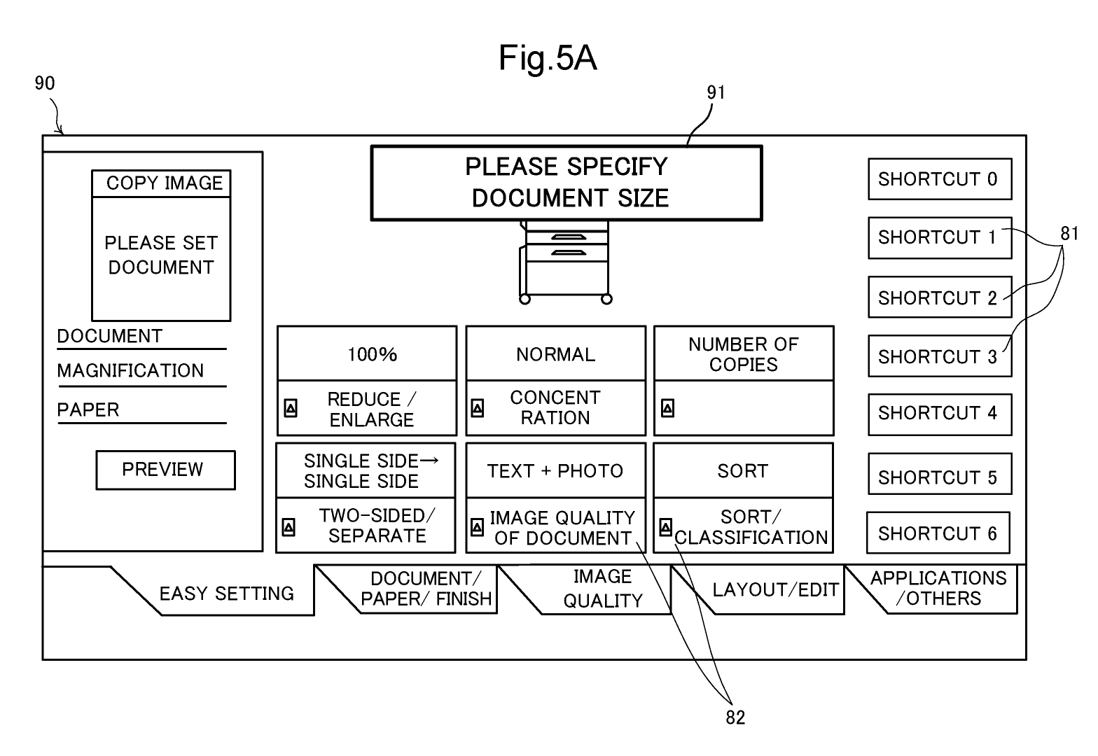

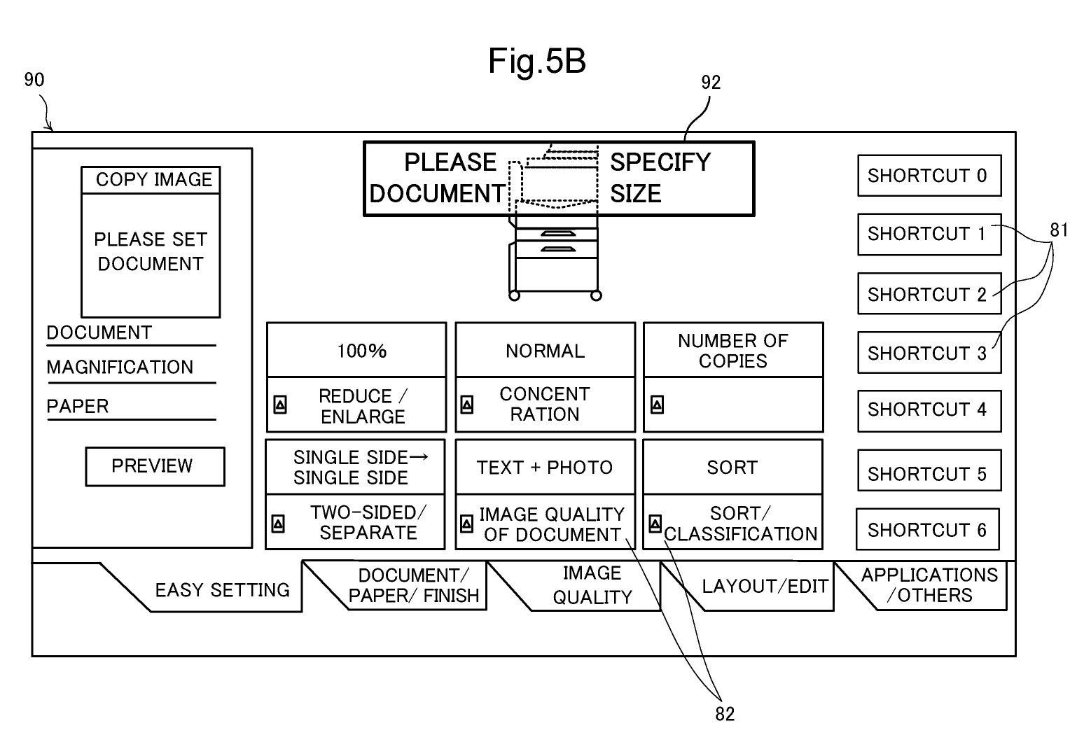

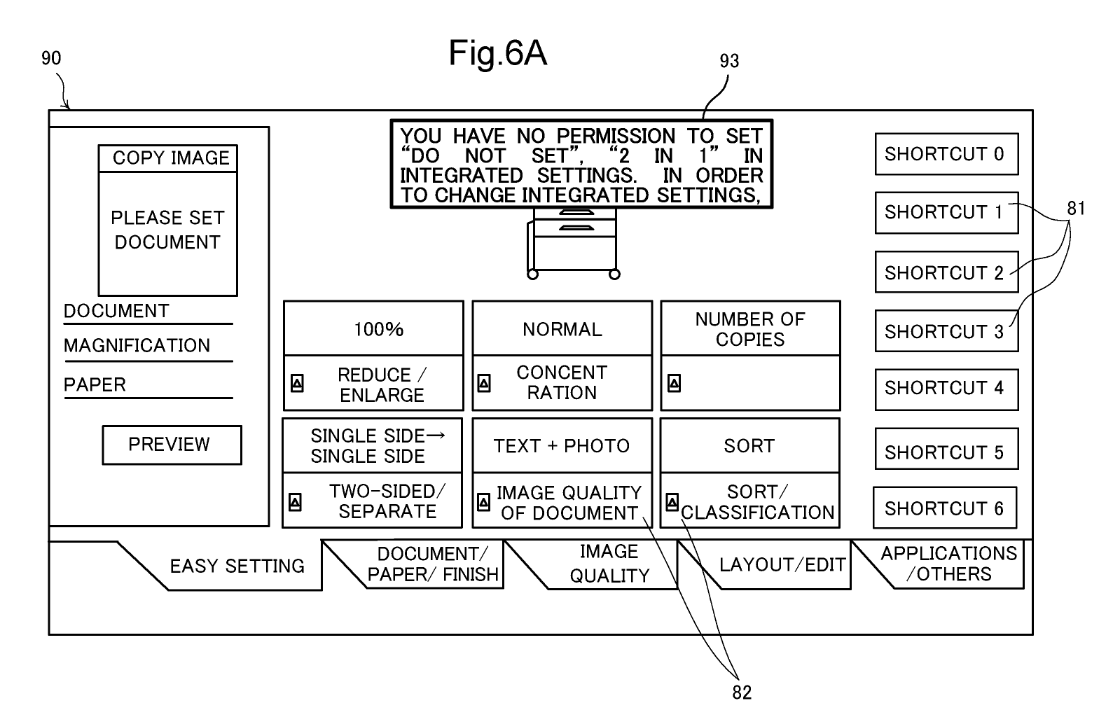

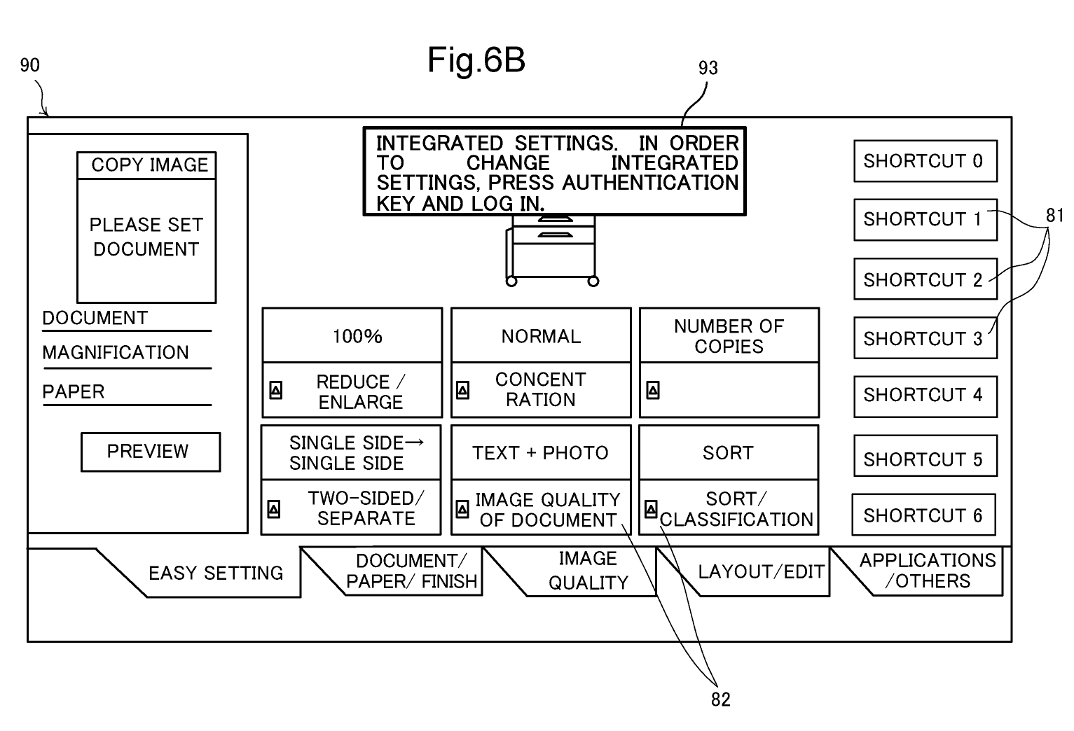

In the image forming device 1 according to the present embodiment, when a notification item for the user is generated during an operation (YES in S1), the message control section 112 instructs the display control section 111 on contents of the message (S2). For example, the message control section 112 may instruct the display control section 111 to display a message of “Please specify the document size.” In this case, the display control section 111 allows the display unit 21 to pop-up display the message at a predetermined pop-up display position in the display screen of the display unit 21 on the initial display screen 90 shown in FIG. 4 only for a predetermined time (for example, 10 seconds) as exemplified in FIG. 5A to FIG. 6B (NO in S3 and S4). That is, FIG. 5A to FIG. 6B are diagrams showing an example of pop-up display. After the predetermined time has passed (YES in S4), the display control section 111 allows the display unit 21 to end the pop-up display (S5), and the display screen 90 returns to the state shown in FIG. 4.

Here, the touch panel 22 detects a touch operation on soft buttons 81 and 82 by the user during the pop-up display.

A pop-up display method will be described in detail. In S3, as shown in FIG. 5A, the display control section 111 allows the display unit 21 to display, on the display screen thereof, the instructed message by a pop-up display 91, for example, at a transmittance of 0% (no transparency) of the pop-up display 91 using a position other than a display region of the soft buttons 81 and 82 as a predetermined display region as a pop-up display position. When the pop-up display 91 is displayed in this manner, the visibility and operability of the soft buttons 81 and 82 for the user are not interfered with.

In addition, the display control section 111 changes a transmittance of the pop-up display when the occurrence of the predetermined event is determined. For example, the display control section 111 allows the display unit 21 to display, on the display screen thereof, the instructed message by a pop-up display 92 at a transmittance of 50% of the pop-up display 92 using a position other than the display region of the soft buttons 81 and 82 as the predetermined display region as a pop-up display position as shown in FIG. 5B. When the pop-up display 92 is displayed in this manner, the visibility and operability of the soft buttons 81 and 82 for the user are not interfered with.

In addition, in S3, for example, when a long sentence message is displayed as a pop-up, the display control section 111 may display the full sentence using a credit title and thus the message may be displayed as an animation flowing from the bottom to the top in units of lines within a pop-up display 93. FIG. 6A and FIG. 6B are diagrams showing a state in which a long sentence message is displayed to flow from the bottom to the top in units of lines within the pop-up display 93. For example, if only a message of a maximum of 3 rows can be displayed within a region of the pop-up display 93, the display control section 111 allows the display unit 21 to display the full sentence using an animation display when a message of 4 or more lines is displayed. In this manner, when a message of a plurality of lines is displayed as an animation, it is possible to effectively deliver message contents to the user.

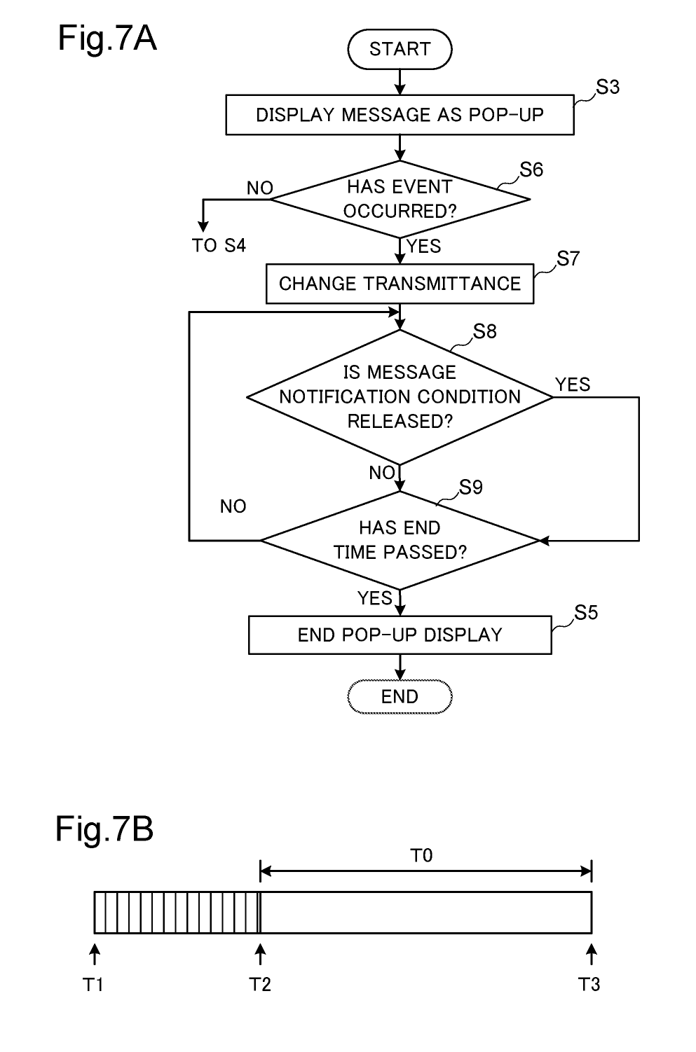

Next, a process when the occurrence of the above event is determined when the pop-up display process is performed will be described with reference to FIG. 7A and FIG. 7B. FIG. 7A is a flowchart showing a process when an event occurs in the pop-up display process performed by the image forming device according to the embodiment of the present disclosure. FIG. 7B is a timing chart showing an example of changing a transmittance in the pop-up display process performed by the image forming device according to the embodiment of the present disclosure. Here, in the following description, a case in which the display control section 111 changes a transmittance between two levels in which a low transmittance is set (for example, a transmittance of 0%) and a high transmittance is set (for example, a transmittance of 50%) as a transmittance of pop-up display will be exemplified. In addition, in FIG. 7B, a section in which a low transmittance is set is hatched and a section in which a high transmittance is set is not hatched (this similarly applies to the following drawings).

When the display control section 111 allows the display unit 21 to pop-up display a message, for example, at a time T1, on the basis of the instruction from the message control section 112 (S3), the determination section 113 determines whether a predetermined event has occurred (S6). Here, when the determination section 113 determines that a predetermined event has not occurred (NO in S6), the process advances to the above S4.

On the other hand, when the determination section 113 determines that a predetermined event has occurred, for example, at a time T2 (YES in S6), the display control section 111 changes a transmittance of the pop-up display on the display unit 21 on the basis of a notification indicating the occurrence of the event from the determination section 113 (S7). For example, as shown in FIG. 7B, the display control section 111 may lower a transmittance of pop-up display and allow the display unit 21 to perform the pop-up display during a period from the time T1 to the time T2 and change the transmittance from a low transmittance to a high transmittance at the time T2 and perform the pop-up display.

For example, the display control section 111 allows the display screen 90 to display the pop-up display 91 shown in FIG. 5A on during a period from the time T1 to the time T2, and display the pop-up display 92 (in a state in which an image under the pop-up display 92 is visible through a transparent display) shown in FIG. 5B from the time T2.

Next, the message control section 112 determines whether a notification condition for a message of the pop-up display that is displayed on the display screen 90 of the display unit 21 by the display control section 111 is released (S8). When the message control section 112 determines that a notification condition of the message is not released (NO in S8), the determination section 113 determines whether the elapsed time (that is, a time elapsed from the time T2 at which the display control section 111 changed the transmittance) measured by the timer 31 has passed a predetermined end time (for example, 10 seconds) (S9).

When the determination section 113 determines that the elapsed time has not passed an end time (NO in S9), the display control section 111 decides that it is necessary to continue the pop-up display, and the process returns to the above S8.

On the other hand, when the determination section 113 determines that the elapsed time has passed an end time (i.e, determines the event), for example, at a time T3 (YES in S9), the display control section 111 decides that it is not necessary to continue the pop-up display, and allows the display unit 21 to end the pop-up display (S5). That is, as shown in FIG. 7B, the display control section 111 increases a transmittance of pop-up display and allows the display unit 21 to perform the pop-up display during a period from the time T2 to the time T3, and allows the display unit 21 to end the pop-up display at the time T3 at which an end time T0 has passed from the time T2. In this manner, in the present embodiment, since the display control section 111 allows the display unit 21 to end the pop-up display at the time T3 at which the elapsed time from the time T2 at which the transmittance is changed has passed the predetermined end time T0, it is possible to prevent the pop-up display from being performed longer than necessary and it is possible to prevent the operability of the image forming device 1 for the user from deteriorating.

On the other hand, when the message control section 112 determines that a notification condition of the message is released (YES in S8), the display control section 111 allows the display unit 21 to end the pop-up display on the basis of the instruction from the message control section 112 even before the end time has passed (S5). Accordingly, in the present embodiment, it is possible to prevent an unnecessary pop-up display from being performed for the user.

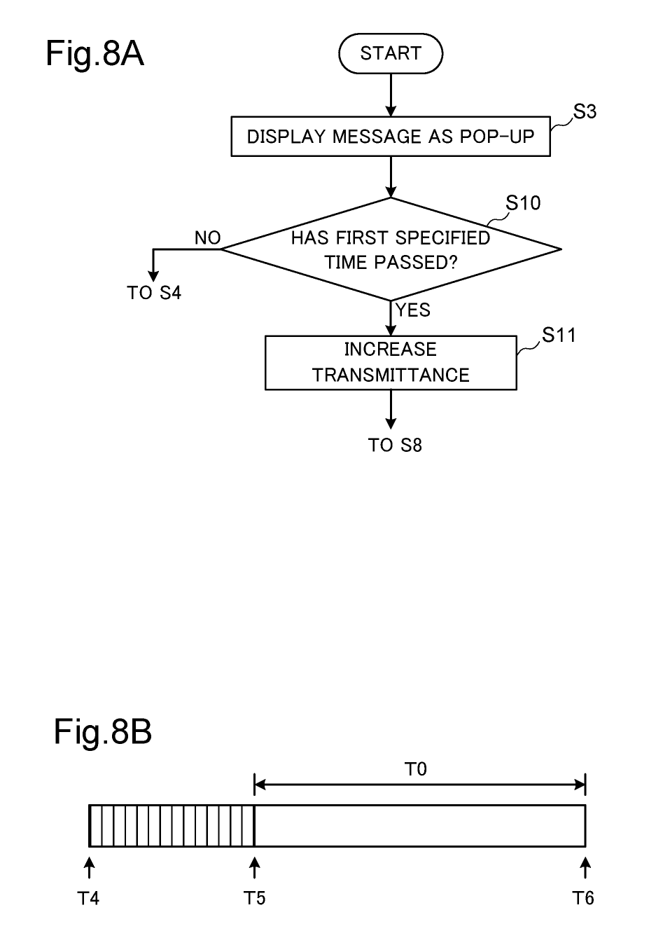

Next, a specific example of the occurrence of a predetermined event in the image forming device 1 and a specific transmittance change operation according to the occurrence of the event will be described with reference to FIG. 8A to FIG. 16B.

### (Time-Elapse Event)

First, a process when a time-elapse event has occurred will be described with reference to FIG. 8A and FIG. 8B. FIG. 8A is a flowchart showing a specific example of a process when an event occurs in the pop-up display process performed by the image forming device according to the embodiment of the present disclosure. FIG. 8B is a timing chart showing an example of changing a transmittance in the pop-up display process performed by the image forming device according to the embodiment of the present disclosure.

When the display control section 111 allows the display unit 21 to pop-up display a message, for example, at a time T4, on the basis of the instruction from the message control section 112 (S3), the determination section 113 determines whether the elapsed time (that is, a time elapsed from the time T4 at which the display control section 111 allowed the display unit 21 to pop-up display the message) measured by the timer 31 has passed a predetermined first specified time (for example, 10 seconds) (S10). That is, the determination section 113 determines whether an event of elapse of time from the time T4 at which the pop-up display is performed has occurred as a predetermined event. Then, when the determination section 113 determines that the first specified time has not passed (NO in S10), the process advances to the above S4.

On the other hand, when the determination section 113 determines that the elapsed time has passed the first specified time, for example, at a time T5, (event) (YES in S10), the display control section 111 increases the transmittance of the pop-up display on the display unit 21 on the basis of a notification indicating the occurrence of the event (time-elapse event) from the determination section 113 (S11). That is, as shown in FIG. 8B, the display control section 111 may lower a transmittance of pop-up display and allow the display unit 21 to perform the pop-up display during a period from the time T4 to the time T5, and change the transmittance from a low transmittance to a high transmittance at the time T5 and allow the display unit 21 to perform the pop-up display. In this manner, since the transmittance of the pop-up display is increased at the time T5 at which the elapsed time from the time T4 at which the pop-up display is performed has passed the first specified time, the user can visually identify an illustration and a soft button displayed under the original pop-up display. Therefore, it is possible to prevent the visibility and operability from deteriorating.

In addition, after the display control section 111 increased the transmittance at the time T5, the process advances to the above S8. Then, for example, when the determination section 113 determines that the elapsed time (that is, a time elapsed from the time T5 at which the display control section 111 increased the transmittance) measured by the timer 31 has passed the end time at a time T6 (event) (YES in S9), the display control section 111 decides that it is not necessary to continue the pop-up display and allows the display unit 21 to end the pop-up display (S5). That is, as shown in FIG. 8B, the display control section 111 increases a transmittance of pop-up display and allows the display unit 21 to perform the pop-up display during a period from the time T5 to the time T6 and to end the pop-up display at the time T6 at which the end time T0 has passed from the time T5.

### (User Event 1)

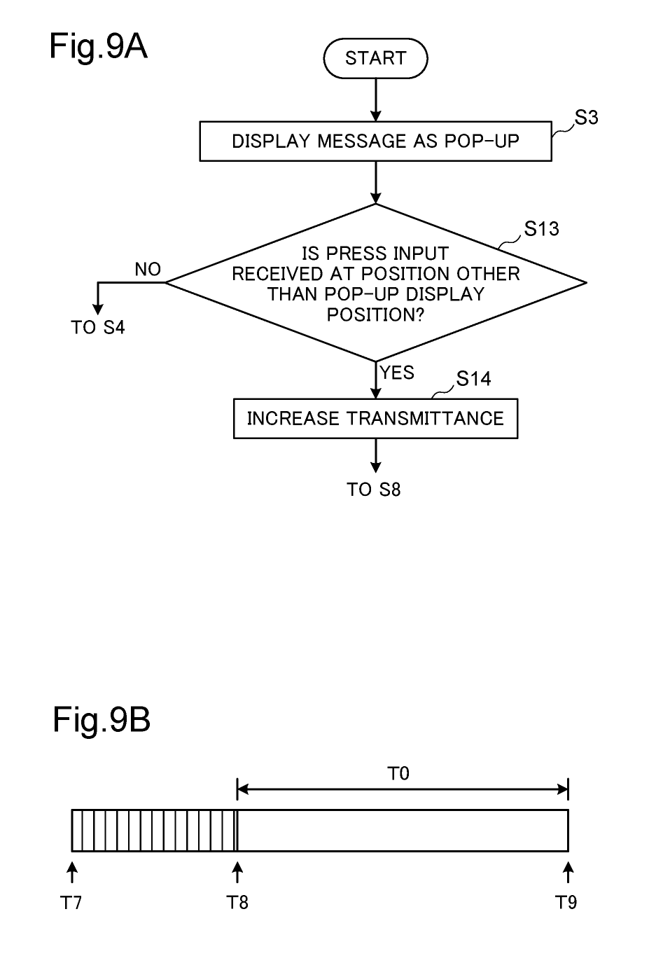

Next, a process when a user event 1 has occurred will be described with reference to FIG. 9A and FIG. 9B. FIG. 9A is a flowchart showing a specific example of a process when an event occurs in the pop-up display process performed by the image forming device according to the embodiment of the present disclosure. FIG. 9B is a timing chart showing an example of changing a transmittance in the pop-up display process performed by the image forming device according to the embodiment of the present disclosure.

When the display control section 111 allows the display unit 21 to pop-up display a message, for example, at a time T7, on the basis of the instruction from the message control section 112 (S3), the determination section 113 determines whether the touch panel 22 has received a press input from the user at a position other than the pop-up display position (S13). That is, the determination section 113 determines whether the user event has occurred as a predetermined event. Then, when the determination section 113 determines that no press input has been received from the user at a position other than the pop-up display position (NO in S13), the process advances to the above S4.

On the other hand, when the determination section 113 determines that a press input has been received from the user at a position other than the pop-up display position, for example, at a time T8, (event) (YES in S13), the display control section 111 increases a transmittance of the pop-up display on the display unit 21 on the basis of a notification indicating the occurrence of the event (user event) from the determination section 113 (S14). That is, when the user performs a press input at a position other than the pop-up display position, the display control section 111 decides that the user desires another operation on the image forming device 1 rather than viewing the message by the pop-up display displayed at the pop-up display position. Then, as shown in FIG. 9B, the display control section 111 may lower a transmittance of pop-up display and allow the display unit 21 to perform the pop-up display during a period from the time T7 to the time T8, and change the transmittance from a low transmittance to a high transmittance at the time T8 and allow the display unit 21 to perform the pop-up display. In this manner, since the transmittance of the pop-up display is increased from the time T8 at which it is determined that a press input from the user has been received at a position other than the pop-up display position, the user can visually identify an illustration and a soft button displayed under the original pop-up display. Therefore, it is possible to prevent the visibility and operability from deteriorating.

In addition, after the display control section 111 increases the transmittance at the time T8, the process advances to the above S8. Then, for example, when the determination section 113 determines that the elapsed time (that is, a time elapsed from the time T8 at which the display control section 111 increased the transmittance) measured by the timer 31 has passed the end time at a time T9 (event) (YES in S9), the display control section 111 decides that it is not necessary to continue the pop-up display and allows the display unit 21 to end the pop-up display (S5). That is, as shown in FIG. 9B, the display control section 111 increases a transmittance of pop-up display and allows the display unit 21 to perform the pop-up display during a period from the time T8 to the time T9 and ends the pop-up display at the time T9 at which the end time T0 has passed from the time T8.

Here, when the pop-up display starts at the time T7, the timer 31 measures an elapsed time from the starting time. However, even if the elapsed time has not passed the first specified time, the display control section 111 increases the transmittance when the determination section 113 determines that a press input (user event) has been received from the user at a position other than the pop-up display position. That is, in the present embodiment, this user event has a higher priority than the time-elapse event, and the transmittance is increased. In addition, after the user event is performed, the display control section 111 does not lower the transmittance.

### (User Event 2)

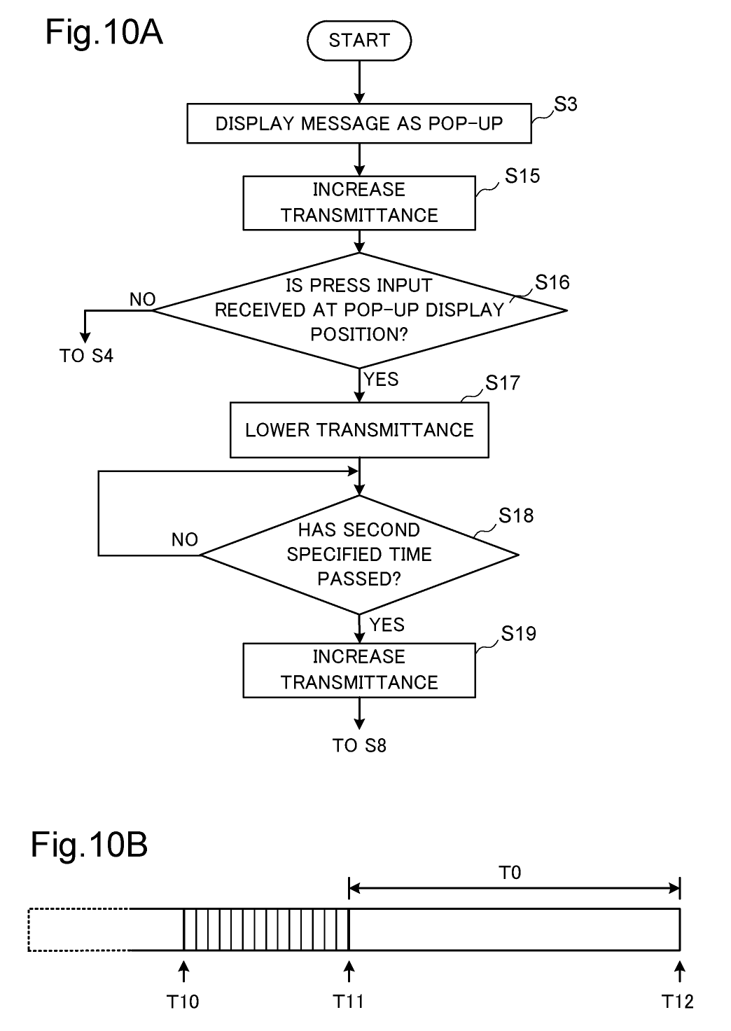

Next, a process when a user event 2 has occurred will be described with reference to FIG. 10A and FIG. 10B. FIG. 10A is a flowchart showing a specific example of a process when an event occurs in the pop-up display process performed by the image forming device according to the embodiment of the present disclosure. FIG. 10B is a timing chart showing an example of changing a transmittance in the pop-up display process performed by the image forming device according to the embodiment of the present disclosure.

After the display control section 111 allowed the display unit 21 to pop-up display a message on the basis of the instruction from the message control section 112 (S3), the display control section 111 increases the transmittance when the first specified time has passed (S15). Then, the determination section 113 determines whether the touch panel 22 has received a press input from the user at a pop-up display position (S16). That is, the determination section 113 determines whether the user event has occurred as a predetermined event. Then, when the determination section 113 determines that no press input has been received from the user at the pop-up display position (NO in S16), the process advances to the above S4.

On the other hand, when the determination section 113 determines that a press input has been received from the user at a pop-up display position, for example, at a time T10 (event) (YES in S16), the display control section 111 may lower a transmittance of the pop-up display on the display unit 21 on the basis of a notification indicating the occurrence of the event (user event) from the determination section 113 (S17). That is, when the user performs a press input at the pop-up display position, the display control section 111 decides that the user desires to identify a message by the pop-up display displayed at the pop-up display position. Then, when the transmittance is lowered by the display control section 111, the user can easily view the message displayed in the pop-up display.

Next, the determination section 113 determines whether the elapsed time (that is, a time elapsed from the time T10 at which the display control section 111 lowered the transmittance) measured by the timer 31 has passed a predetermined second specified time (for example, 10 seconds) (S18). That is, the determination section 113 determines whether an event of elapse of time from the time T10 at which the transmittance is lowered has occurred as a predetermined event. Then, when the determination section 113 determines that the second specified time has not passed (NO in S18), the display control section 111 repeats the determination until the second specified time has passed.

On the other hand, when the determination section 113 determines that the elapsed time has passed the second specified time, for example, at a time T11, (event) (YES in S18), the display control section 111 increases the transmittance of the pop-up display on the display unit 21 on the basis of a notification indicating the occurrence of the event (time-elapse event) from the determination section 113 (S19). That is, as shown in FIG. 10B, the display control section 111 may lower a transmittance of pop-up display and allow the display unit 21 to perform the pop-up display during a period from the time T10 to the time T11, and change the transmittance from a low transmittance to a high transmittance at the time T11 and allow the display unit 21 to perform the pop-up display. In this manner, since the transmittance of the pop-up display is increased at the time T11 at which the elapsed time from the time T10 at which the pop-up display is performed has passed the second specified time, the user can visually identify an illustration and a soft button displayed under the original pop-up display. Therefore, it is possible to prevent the visibility and operability from deteriorating.

In addition, after the display control section 111 increases the transmittance at the time T11, the process advances to the above S8. Then, for example, when the determination section 113 determines that the elapsed time (that is, a time elapsed from the time T11 at which the display control section 111 increased the transmittance) measured by the timer 31 has passed the end time at a time T12 (event) (YES in S9), the display control section 111 decides that it is not necessary to continue the pop-up display and ends the pop-up display (S5). That is, as shown in FIG. 10B, the display control section 111 increases a transmittance of pop-up display and allows the display unit 21 to perform the pop-up display during a period from the time T11 to the time T12 and ends the pop-up display at the time T12 at which the end time T0 has passed from the time T11.

### (System Occurrence Event 1)

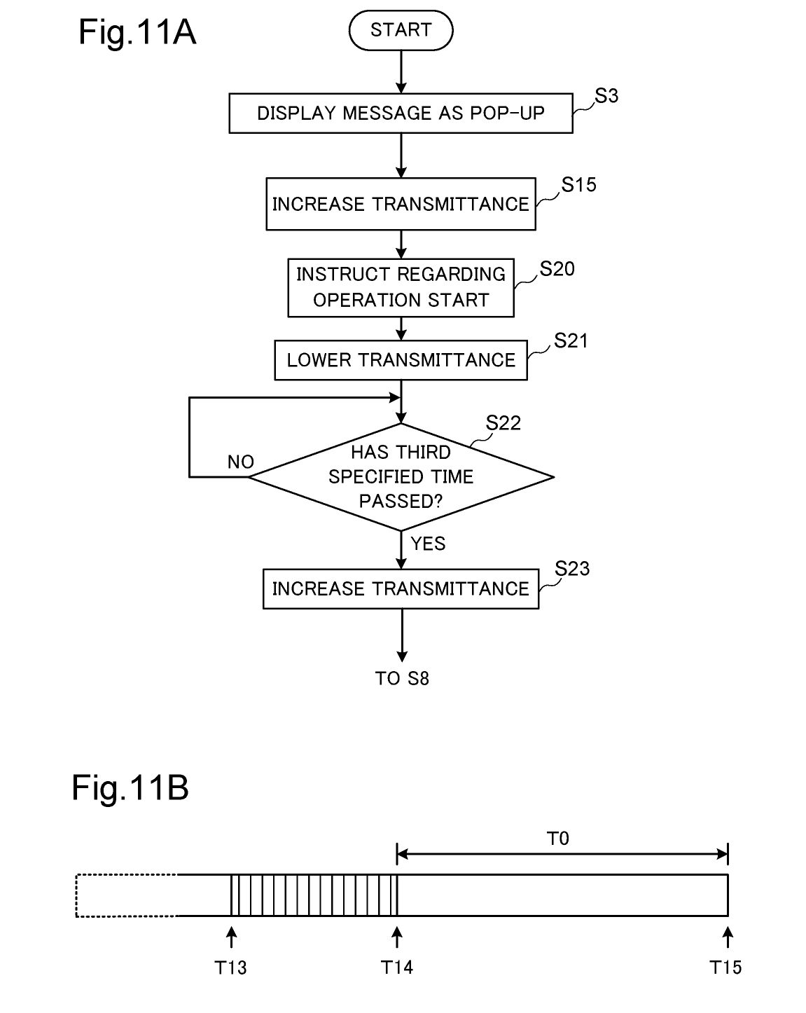

Next, a process when a system occurrence event 1 has occurred will be described with reference to FIG. 11A and FIG. 11B. FIG. 11A is a flowchart showing a specific example of a process in which an event occurs in the pop-up display process performed by the image forming device according to the embodiment of the present disclosure. FIG. 11B is a timing chart showing an example of changing a transmittance in the pop-up display process performed by the image forming device according to the embodiment of the present disclosure.

The display control section 111 allows the display unit 21 to pop-up display a message on the basis of the instruction from the message control section 112 (S3). In this case, the display control section 111 is arranged in a manner such as to allow the display unit 21 to pop-up display a predetermined start prohibition message for prohibiting start of an operation in the image forming device 1 as the pop-up display. Then, the display control section 111 increases the transmittance when the first specified time has passed (S15).

Next, when the determination section 113 determines the start button 23 that has received a press input instructing operation start from the user, for example, at a time T13, as a predetermined event (S20), the display control section 111 may lower a transmittance of the pop-up display in the pop-up display on the display unit 21 on the basis of a notification indicating the occurrence of the event (system occurrence event) from the determination section 113 (S21). That is, the display control section 111 decides that the user does not accurately understand the start prohibition message despite the start prohibition message being displayed as a pop-up. Then, when the transmittance is lowered by the display control section 111, the user can easily view the message displayed in the pop-up display.

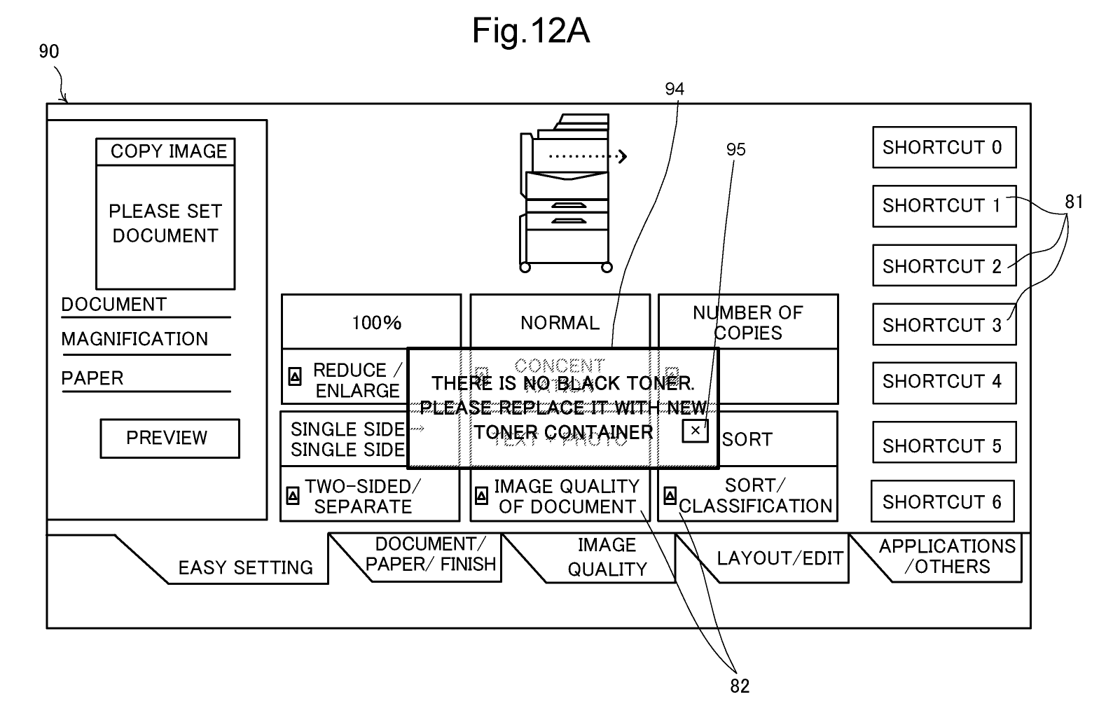

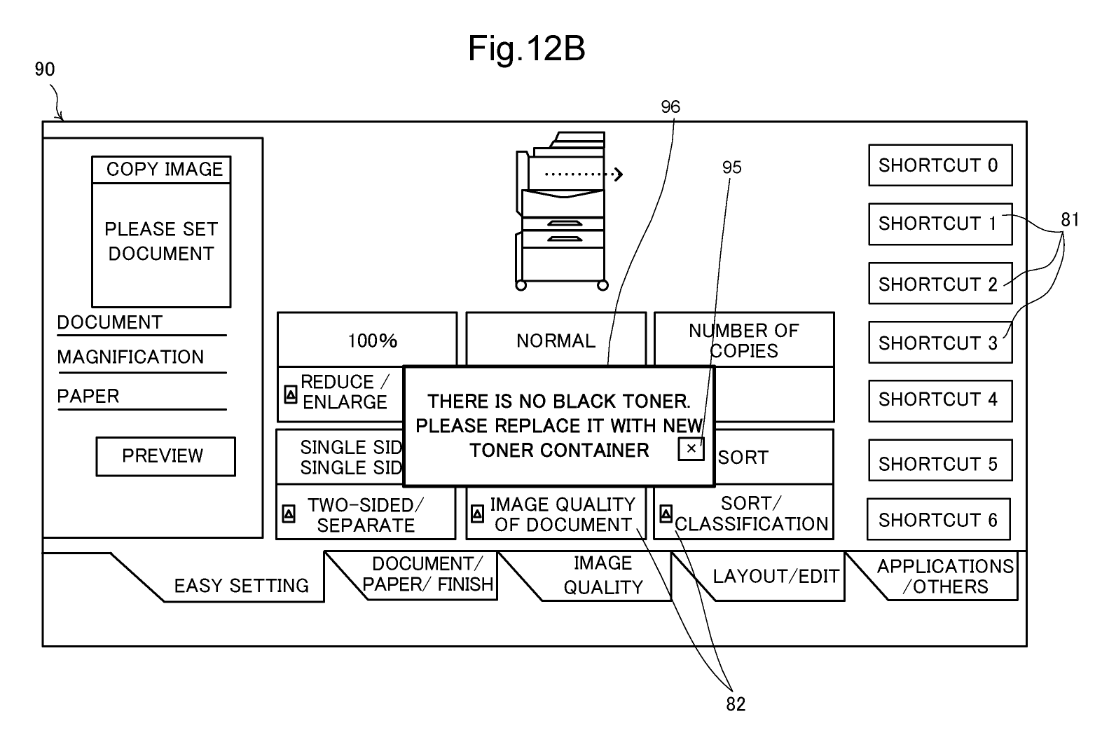

For example, as shown in FIG. 12A, the display control section 111 allows the display unit 21 to pop-up display a start prohibition message of “There is no black toner. Please replace with a new toner container” in a pop-up display 94 at a transmittance of 50% on the display screen 90. While the pop-up display 94 is displayed, when the determination section 113 determines that the user has pressed the start button 23, as shown in FIG. 12B, the display control section 111 allows the display unit 21 to display the start prohibition message in a pop-up display 96 at a transmittance of 0% on the display screen 90, and thus the start prohibition message can be emphasized and the user can easily view the message. Here, for example, a close button 95 is display in the pop-up display 94. When the touch panel 22 detects that the user touched the close button 95, the display control section 111 allows the display unit 21 to end the pop-up display 94 before the predetermined time has passed.

Next, the determination section 113 determines whether the elapsed time (that is, a time elapsed from the time T13 at which the display control section 111 lowered the transmittance) measured by the timer 31 has passed a predetermined third specified time (for example, 10 seconds) (S22). That is, the determination section 113 determines whether an event of elapse of time from the time T13 at which the transmittance is lowered has occurred as a predetermined event. Then, when the determination section 113 determines that the third specified time has not passed (NO in S22), the display control section 111 repeats the determination until the third specified time has passed.

On the other hand, the determination section 113 determines that the elapsed time has passed the third specified time, for example, at a time T14, (event) (YES in S22), the display control section 111 increases the transmittance of the pop-up display on the display unit 21 on the basis of a notification indicating the occurrence of the event (time-elapse event) from the determination section 113 (S23). That is, as shown in FIG. 11B, the display control section 111 may lower a transmittance of pop-up display and allow the display unit 21 to perform the pop-up display during a period from the time T13 to the time T14, and change the transmittance from a low transmittance to a high transmittance at the time T14 and allow the display unit 21 to perform the pop-up display. In this manner, since the transmittance of the pop-up display is increased at the time T14 at which the elapsed time from the time T13 at which the pop-up display is performed has passed the third specified time, the user can visually identify an illustration and a soft button displayed under the original pop-up display. Therefore, it is possible to prevent the visibility and operability from deteriorating.

In addition, after the display control section 111 increases the transmittance at the time T14, the process advances to the above S8. Then, for example, when the determination section 113 determines that the elapsed time (that is, a time elapsed from the time T14 at which the display control section 111 increased the transmittance) measured by the timer 31 has passed the end time at a time T15 (event) (YES in S9), the display control section 111 decides that it is not necessary to continue the pop-up display and ends the pop-up display (S5). That is, as shown in FIG. 11B, the display control section 111 increases a transmittance of pop-up display and allows the display unit 21 to perform the pop-up display during a period from the time T14 to the time T15, and allows the display unit 21 to end the pop-up display at the time T15 at which the end time T0 has passed from the time T14.

### (System Occurrence Event 2)

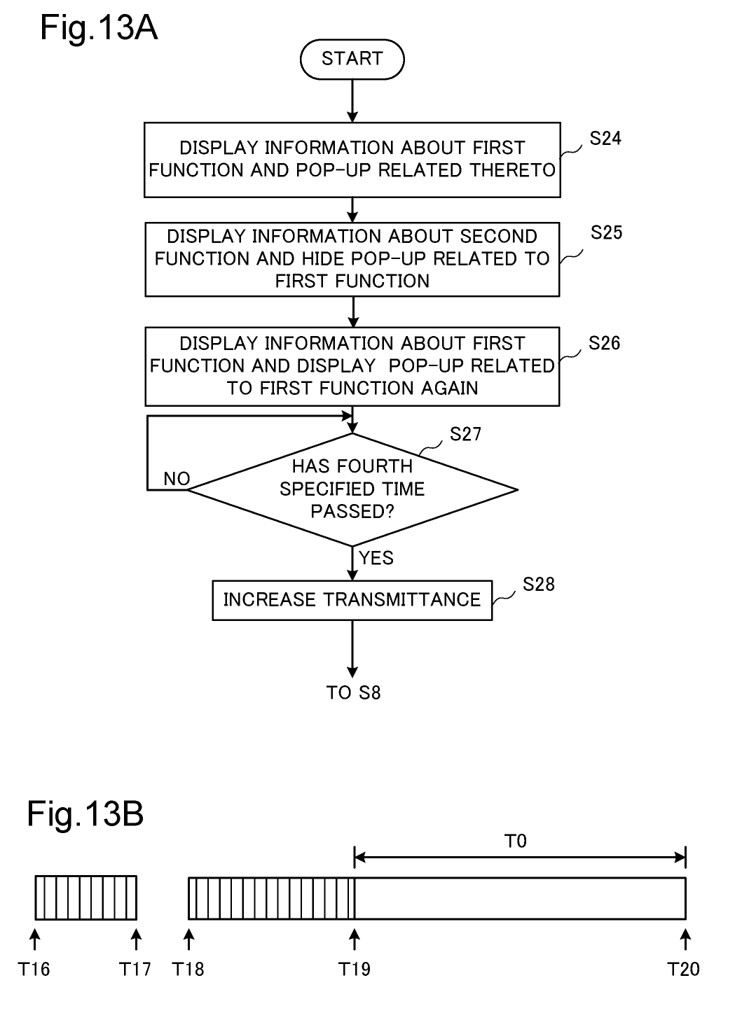

Next, a process when a system occurrence event 2 has occurred will be described with reference to FIG. 13A and FIG. 13B. FIG. 13A is a flowchart showing a specific example of a process in which an event occurs in the pop-up display process performed by the image forming device according to the embodiment of the present disclosure. FIG. 13B is a timing chart showing an example of changing a transmittance in the pop-up display process performed by the image forming device according to the embodiment of the present disclosure.

The display control section 111 allows the display unit 21 to pop-up display a message, for example, at a time T16, on the basis of the instruction from the message control section 112 (S24). In this case, the display control section 111 is arranged in a manner such as to allow the display unit 21 to pop-up display information about a predetermined first function in the image forming device 1 and a pop-up related to the first function on the display screen 90 of the display unit 21.

Next, if the display control section 111 is requested from display information about a predetermined second function in the image forming device 1 on the display screen 90 of the display unit 21 when the user operates the image forming device 1, for example, at a time T17, the display control section 111 allows the display unit 21 to display information about the second function in place of information about the first function on the display screen 90 and hide the pop-up related to the first function (S25). That is, the determination section 113 determines that an event of function transition from display of the information about the first function to display of the information about the second function has occurred, and displays the information about the second function that is requested from the display control section 111. For example, as shown in FIG. 13B, the display control section 111 allows the display unit 21 to display the information about the first function and the pop-up related to the first function during a period from the time T16 to the time T17, to display the information about the second function in place of the information about the first function at the time T17, and to stop the display of the pop-up related to the first function. Therefore, in the present embodiment, it is possible to appropriately display a pop-up according to a function performed in the image forming device 1 and it is possible to improve the convenience and operability of the image forming device 1 for the user.

Then, if the display control section 111 is requested from display the information about the first function again on the display screen 90 of the display unit 21 when the operation of the second function ends, for example, at a time T18, the display control section 111 allows the display unit 21 to display the information about the first function in place of the information about the second function on the display screen 90 and display the pop-up related to the first function again (S26). That is, the determination section 113 determines that an event of function transition from display of the information about the second function to display of the information about the first function has occurred and displays the information about the first function that is requested from the display control section 111.

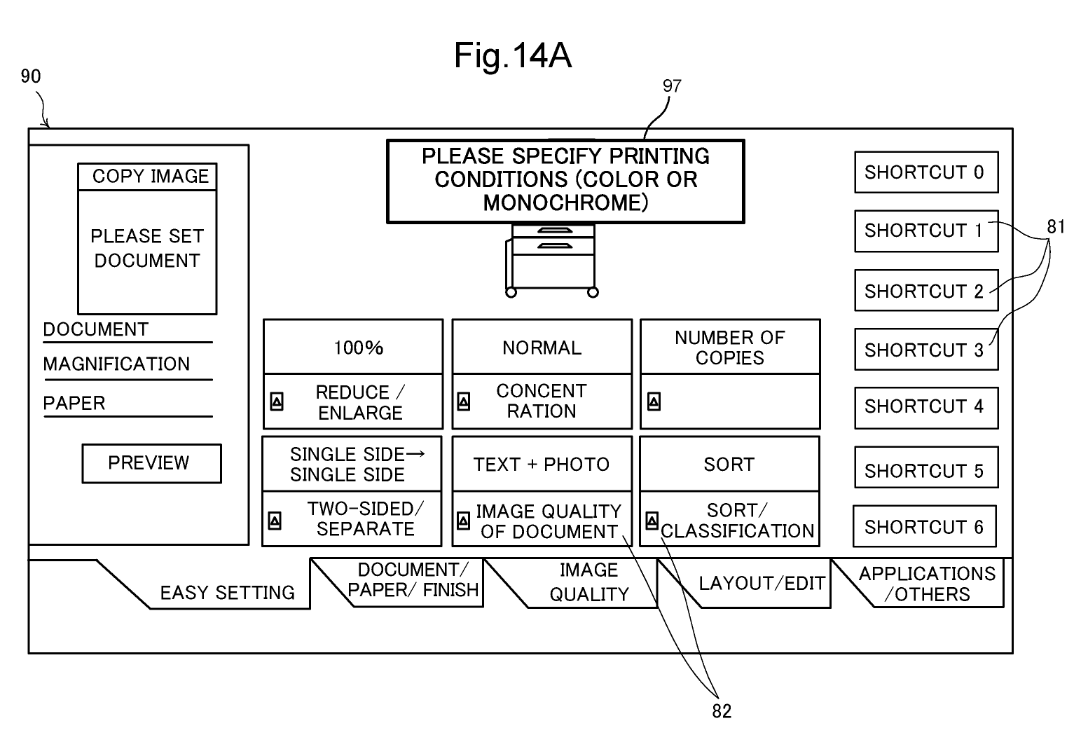

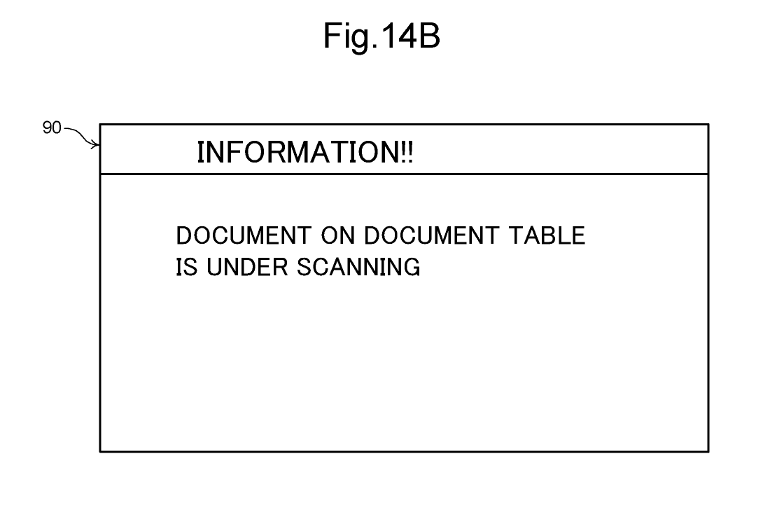

For example, when the display control section 111 is requested from display information about a print job in the display unit 21 as the information about the first function, as shown in FIG. 14A, the display control section 111 allows the display unit 21 to display a message related to the first function of “Please specify printing conditions (color or monochrome),” in a pop-up display 97 on the display screen 90. While the pop-up display 97 is displayed, when the determination section 113 determines that, for example, the user has operated an operation unit (not shown) and thus execution of a scan operation (second function) has been requested from the image forming device 1, the display control section 111 allows the display unit 21 to display the information about the second function on the display screen 90. That is, as shown in FIG. 14B, the display control section 111 allows the display unit 21 to display a message (information about the second function) of “document on document table is under scanning” on the display screen 90. Then, when the determination section 113 determines that a scan operation has ended and additionally the user has operated the operation unit and thus execution of a copy operation (first function) has been requested from the image forming device 1, the display control section 111 allows the display unit 21 to display the information about the first function in place of the information about the second function and display the pop-up display related to the first function again. That is, the display control section 111 changes the display screen 90 shown in FIG. 14B to the display screen 90 shown in FIG. 14A. In this manner, in the present embodiment, when display on the display screen 90 is returned from the information about the second function to the information about the first function, since the pop-up display related to the first function is displayed again, the user can reliably view the message in the pop-up display.

Next, the determination section 113 determines whether the elapsed time (that is, a time elapsed from the time T18 at which the display control section 111 allowed the display unit 21 to display the pop-up related to the first function display again) measured by the timer 31 has passed a predetermined fourth specified time (for example, 10 seconds) (S27). That is, the determination section 113 determines whether an event of elapse of time from the time T18 at which the pop-up display is performed again has occurred as a predetermined event. Then, when the determination section 113 determines that the fourth specified time has not passed (NO in S27), the display control section 111 repeats the determination until the fourth specified time has passed.

On the other hand, the determination section 113 determines that the elapsed time has passed the fourth specified time, for example, at a time T19, (event) (YES in S27), the display control section 111 increases the transmittance of the pop-up display on the display unit 21 on the basis of a notification indicating the occurrence of the event (time-elapse event) from the determination section 113 (S28). That is, as shown in FIG. 13B, the display control section 111 may lower a transmittance of pop-up display and allow the display unit 21 to perform the pop-up display during a period from the time T18 to the time T19, and change the transmittance from a low transmittance to a high transmittance at the time T19 and allow the display unit 21 to perform the pop-up display. In this manner, since the transmittance of the pop-up display is increased at the time T19 at which the elapsed time from the time T18 at which the pop-up display is performed has passed the fourth specified time, the user can visually identify an illustration and a soft button displayed under the original pop-up display. Therefore, it is possible to prevent the visibility and operability from deteriorating.

In addition, after the display control section 111 increases the transmittance at the time T19, the process advances to the above S8. Then, for example, when the determination section 113 determines that the elapsed time (that is, a time elapsed from the time T19 at which the display control section 111 increased the transmittance) measured by the timer 31 has passed the end time at a time T20 (event) (YES in S9), the display control section 111 decides that it is not necessary to continue the pop-up display and ends the pop-up display (S5). That is, as shown in FIG. 13B, the display control section 111 increases a transmittance of pop-up display and allows the display unit 21 to perform the pop-up display during a period from the time T19 to the time T20 and ends the pop-up display at the time T20 at which the end time T0 has passed from the time T19.

### (System Occurrence Event 3)

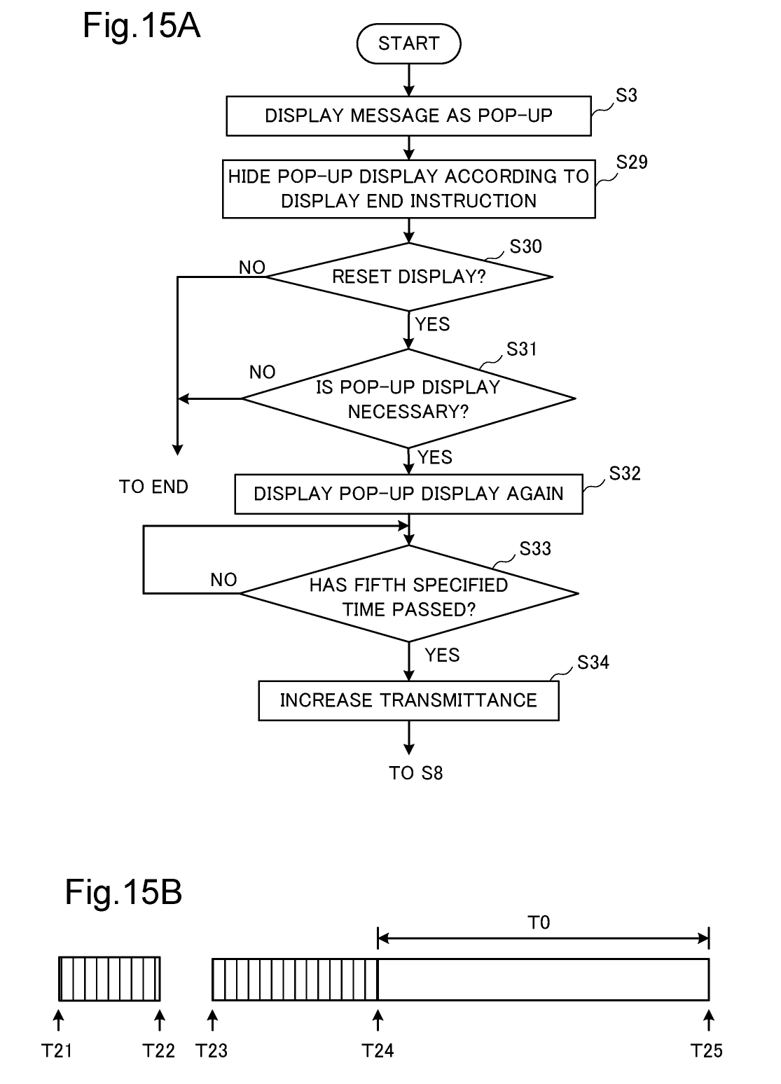

Next, a process when a system occurrence event 3 has occurred will be described with reference to FIG. 15A and FIG. 15B. FIG. 15A is a flowchart showing a specific example of a process in which an event occurs in the pop-up display process performed by the image forming device according to the embodiment of the present disclosure. FIG. 15B is a timing chart showing an example of changing a transmittance in the pop-up display process performed by the image forming device according to the embodiment of the present disclosure.

The display control section 111 allows the display unit 21 to pop-up display a message on the basis of the instruction from the message control section 112, for example, at a time T21 (S3). In this case, the display control section 111 is arranged in a manner such as to allow the display unit 21 to display the close button 95 shown in FIG. 12A in the pop-up display on the display screen 90 of the display unit 21. Then, while the pop-up display can be displayed, if the user presses the close button 95, for example, at a time T22, and thus the display control section 111 receives the pop-up display end instruction, the display control section 111 allows the display unit 21 to hide the pop-up display on the basis of the instruction from the user (S29). That is, as shown in FIG. 15B, the display control section 111 allows the display unit 21 to perform the pop-up display during a period from the time T21 to the time T22 and to stop the pop-up display at the time T22.

Then, the determination section 113 determines whether a predetermined display reset has been performed on the display screen 90 (S30). That is, the determination section 113 determines whether it is necessary to reset contents displayed on the display screen 90 according to an operation of the user. Then, when the determination section 113 determines that a display reset has not been performed (NO in S30), the process ends.

On the other hand, when the determination section 113 determines that a display reset has been performed (event) (YES in S30), the display control section 111 determines whether it is necessary to display the pop-up display hidden in S29 (S31). That is, the display control section 111 determines whether the hidden pop-up display can be displayed. Then, when the display control section 111 determines that it is not necessary to display the pop-up display (NO in S31), the process ends.

On the other hand, when the display control section 111 determines that it is necessary to display the pop-up display, for example, at a time T23, (YES in S31), the display control section 111 allows the display unit 21 to perform the pop-up display again (S32). That is, the determination section 113 determines that an event of display return of the pop-up display from a state in which the pop-up display is temporarily closed has occurred and causes the display control section 111 to display the temporarily hidden pop-up display again. In this manner, in the present embodiment, when a predetermined display reset is performed on the display screen 90 while the pop-up display can be displayed, since the pop-up display is displayed again, the user can reliably view the message in the pop-up display.

Next, the determination section 113 determines whether the elapsed time (that is, a time elapsed from the time T23 at which the display control section 111 allows the display unit 21 to display a temporarily hidden pop-up display again) measured by the timer 31 has passed a predetermined fifth specified time (for example, 10 seconds) (S33). That is, the determination section 113 determines whether an event of elapse of time from the time T23 at which the pop-up display is performed again has occurred as a predetermined event. Then, when the determination section 113 determines that the fifth specified time has not passed (NO in S33), the display control section 111 repeats the determination until the fifth specified time has passed.

On the other hand, when the determination section 113 determines that the elapsed time has passed the fifth specified time, for example, at a time T24, (event) (YES in S33), the display control section 111 increases the transmittance of the pop-up display on the display unit 21 on the basis of a notification indicating the occurrence of the event (time-elapse event) from the determination section 113 (S34). That is, as shown in FIG. 15B, the display control section 111 may lower a transmittance of pop-up display and allow the display unit 21 to perform the pop-up display during a period from the time T23 to the time T24, and change the transmittance from a low transmittance to a high transmittance at the time T24 and allow the display unit 21 to perform the pop-up display. In this manner, since the transmittance of the pop-up display is increased at the time T24 at which the elapsed time from the time T23 at which the pop-up display is performed has passed the fifth specified time, the user can visually identify an illustration and a soft button displayed under the original pop-up display. Therefore, it is possible to prevent the visibility and operability from deteriorating.

In addition, after the display control section 111 increases the transmittance at the time T24, the process advances to the above S8. Then, for example, when the determination section 113 determines that the elapsed time (that is, a time elapsed from the time T24 at which the display control section 111 increased the transmittance) measured by the timer 31 has passed the end time at a time T25 (event) (YES in S9), the display control section 111 decides that it is not necessary to continue the pop-up display and ends the pop-up display (S5). That is, as shown in FIG. 15B, the display control section 111 increases a transmittance of pop-up display and allows the display unit 21 to perform the pop-up display during a period from the time T24 to the time T25 ends the pop-up display at the time T25 at which the end time T0 has passed from the time T24.

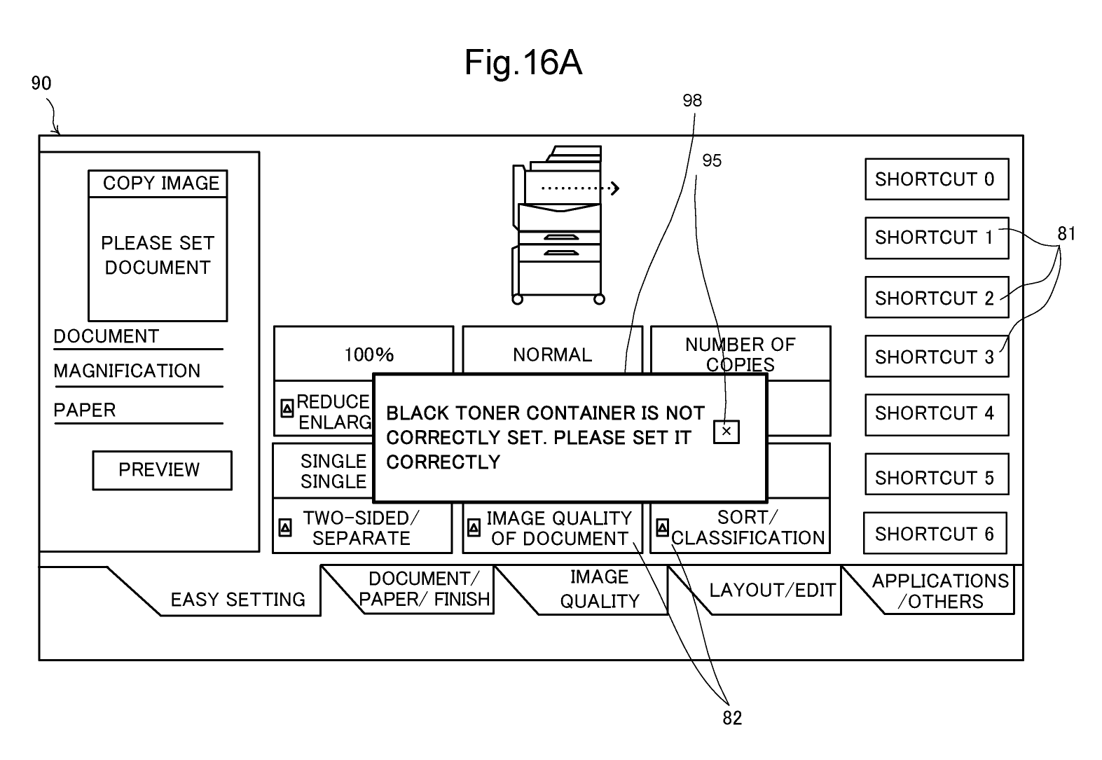

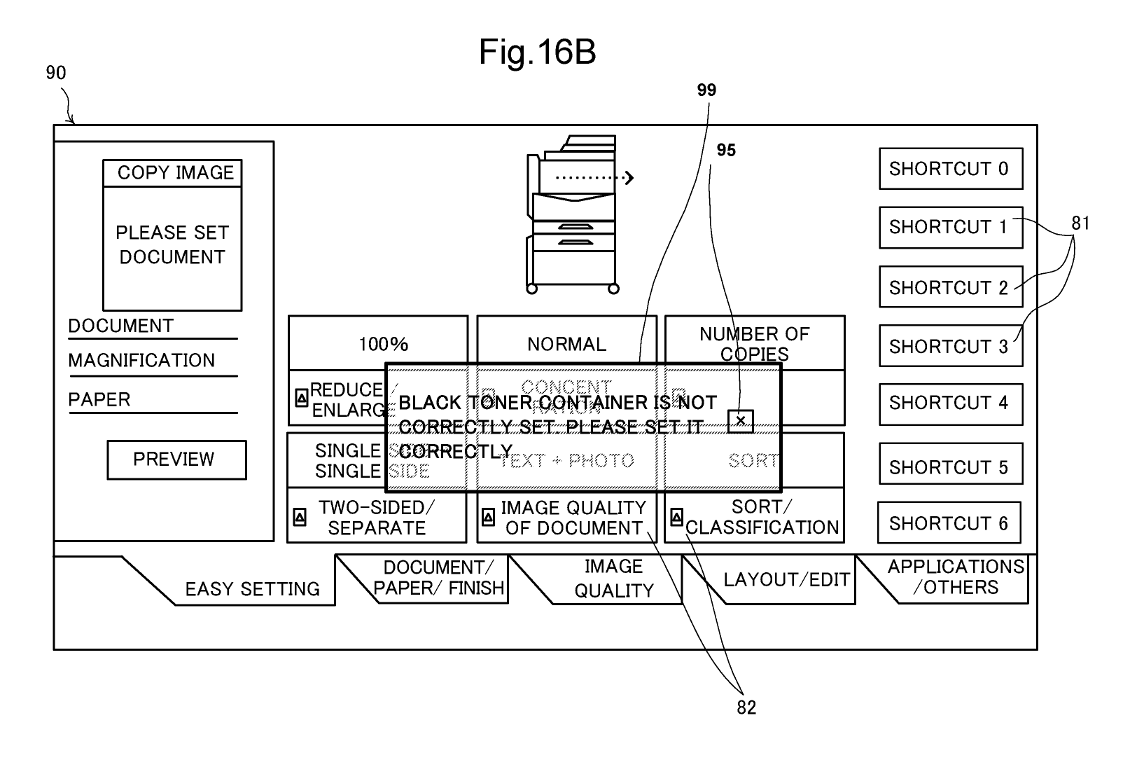

For example, as shown in FIG. 16A, the display control section 111 allows the display unit 21 to display a message of “The black toner container is not correctly set. Please set correctly” and the close button 95 in a pop-up display 98 on the display screen 90. Then, the display control section 111 allows the display unit 21 to hide the pop-up display 98 when the user presses the close button 95. Then, when the user performs a toner container replacement operation, the determination section 113 determines that a display reset has been performed on the display screen 90. Next, when the determination section 113 determines that a toner container replacement operation has not been performed appropriately, as shown in FIG. 16A, the display control section 111 allows the display unit 21 to display the pop-up display 98 again. Then, when the determination section 113 determines that the fifth specified time has passed from display of the pop-up display 98 again, as shown in FIG. 16B, the display control section 111 allows the display unit 21 to display the pop-up display 99 in which only the transmittance is increased without changing the message on the display screen 90. Accordingly, since the user can view the message in a pop-up display 99 more reliably and the user can visually identify an illustration and a soft button displayed under the pop-up display 99, it is possible to prevent the visibility and operability from deteriorating.

As described above, in the image forming device 1 according to the present embodiment, a fixed region for message display is not provided on the display screen of the display unit 21 and the message is displayed as a pop-up at a pop-up display position set at a position other than the predetermined display region. According to the pop-up display of the message, the user can recognize a change in state of the message or the device even if there is no fixed message region.

Accordingly, in the image forming device 1, since the fixed region is not provided on the display screen to be displayed on the display unit 21, it is possible to display some information on the entire display screen of the display unit 21 always, and it is possible to effectively use the entire display screen. In addition, even if a new message is displayed as a pop-up, the user can reliably view important information displayed on the display unit 21 up to that time, for example, the soft buttons 81 and 82.

In addition, even during the pop-up display, since the touch panel 22 receives a press input of the soft buttons 81 and 82 on the display screen of the display unit 21, an operation of the user on the soft buttons 81 and 82 is not interfered with by the display of the pop-up display. Therefore, the operability of the image forming device 1 does not deteriorate due to the pop-up display.

In addition, according to a message display by the pop-up display at a pop-up display position other than the predetermined display region on the display screen of the display unit 21, the user can easily recognize a newly displayed message and change in contents displayed, compared to a case where a message is being displayed in a fixed region.

Further, when the determination section 113 determines that a predetermined event has occurred, the display control section 111 changes the transmittance of the pop-up display. Accordingly, in the present embodiment, a display area of the display unit 21 is effectively used and the user recognizes a message intuitively, efficiently, and more easily, and obstacles to the operability such as important information displayed up to that time not being visible due to a new message display by the pop-up display are prevented as much as possible. Therefore, it is possible to improve convenience for the user.

Incidentally, in a general display input device, if a banner is displayed when there are many items to be displayed, there is a problem of important information displayed up to that time being not visible due to the banner display. Further, in the first method described in the background art, when a banner is displayed, it is not possible to operate the displayed soft button. In addition, the second method described in the background art is a method in which it is possible to instantly cope with a change in state such as mail reception while a lock screen is displayed, but it cannot solve the problem.

On the other hand, in the present embodiment, a display area of the display unit is effectively used and the user recognizes a message intuitively, efficiently, and more easily, and obstacles to the operability such as important information displayed up to that time not being visible due to a new message display pop-up are prevented as much as possible. Therefore, it is possible to improve convenience for the user.

In addition, while a case in which the display control section changes the transmittance between two levels (0% and 50%) has been described in the above description, the present disclosure is not limited thereto. For example, the transmittance may be changed among three levels or more according to an importance level of a message.

In addition, the configurations and processes described with reference to FIG. 1 to FIG. 16B are only an embodiment of the present disclosure, and the present disclosure is not limited to the configurations and processes.

While the present disclosure has been described in detail with reference to the embodiments thereof, it would be apparent to those skilled in the art the various changes and modifications may be made therein within the scope defined by the appended claims.

What is claimed is:

1. A display input device comprising:
a display unit;
a touch panel that is disposed on the display unit and is configured to receive a press input on a soft button displayed on a display screen of the display unit; and
a control unit that includes a processor and, when the processor executes a control program, functions as:
a display control section that controls a display of the display screen to be displayed on the display unit;
a message control section that controls whether to display a message on the display unit; and
a determination section that determines whether a predetermined event occurred,
wherein upon receiving a message display instruction from the message control section in a state of allowing the display unit to display the display screen, the display control section allows the display unit to display, as a pop-up display, the message whose display was instructed, at a predetermined pop-up display position in a display region of the display screen,
the touch panel receives the press input to the soft button even while the message is displayed as the pop-up by the display control section, and
when the determination section determines that the predetermined event has occurred, the display control section changes a transmittance of the pop-up display.

2. The display input device according to claim 1, further comprising a timer configured to measure time, wherein
the timer measures a time elapsed from a start time of the pop-up display by the display control section, and
when the determination section determines, as the event, that the time elapsed being measured by the timer has elapsed for a predetermined first specified time, the display control section increases the transmittance.

3. The display input device according to claim 1, wherein when the determination section determines, as the event, that the touch panel has received the press input from a user at a position other than the pop-up display position in the display region, the display control section increases the transmittance.

4. The display input device according to claim 2, wherein after increasing the transmittance, when the determination section determines, as the event, that the touch panel has received the press input from a user at the pop-up display position, the display control section lowers the transmittance.

5. The display input device according to claim 4, wherein
the timer additionally measures a time elapsed from a time at which the display control section lowered the transmittance, and
when the determination section determines, as the event, that the time elapsed being measured by the timer has additionally elapsed for a predetermined second specified time, the display control section increases the transmittance again.

6. The display input device according to claim 2, further comprising a start button configured to receive the press input through which a user inputs an instruction to start an operation, wherein
in a state of increasing the transmittance and allowing the display unit to perform the pop-up display of a predetermined start prohibition message for prohibiting the operation start on the display screen, when the determination section determines, as the event, that the start button has received, from the user, the input of the instruction to start the operation whose start is prohibited, the display control section lowers the transmittance.

7. The display input device according to claim 6, wherein
the timer additionally measures a time elapsed from a time at which the display control section lowered the transmittance, and
when the determination section determines, as the event, that the time elapsed being measured by the timer has elapsed for a predetermined third specified time, the display control section increases the transmittance.

8. The display input device according to claim 2, wherein in a state of allowing the display unit to display information about a predetermined first function and a pop-up related to the first function on the display screen, when the display control section allows the display unit to display information about a predetermined second function on the display screen in place of the information about the first function, the display control section allows the display unit to hide the pop-up related to the first function.

9. The display input device according to claim 8, wherein after allowing the display unit to hide the pop-up related to the first function, when the display control section allows the display unit to display the information about the first function in place of the information about the second function on the display screen, the display control section allows the display unit to display the pop-up related to the first function again on the display screen.

10. The display input device according to claim 9, wherein
the timer additionally measures a time elapsed from a time at which the display control section allowed the display unit to display the pop-up related to the first function again on the display screen, and
when the determination section determines, as the event, that the time elapsed being measured by the timer has elapsed for a predetermined fourth specified time, the display control section increases the transmittance.

11. The display input device according to claim 2, wherein after allowing the display unit to end the pop-up display according to an instruction from a user, when the determination section determines, as the event, that a predetermined display reset is performed on the display screen while the pop-up display is able to be displayed, the display control section allows the display unit to perform the pop-up display again.

12. The display input device according to claim 11, wherein
the timer additionally measures a time elapsed from a time at which the display control section allowed the display unit to perform the pop-up display again, and
when the determination section determines, as the event, that the time elapsed being measured by the timer has elapsed for a predetermined fifth specified time, the display control section increases the transmittance.

13. The display input device according to claim 2, wherein
the timer additionally measures a time elapsed from a time at which the display control section changed the transmittance, and
when the determination section determines, as the event, that the time elapsed being measured by the timer has elapsed for a predetermined end time, the display control section allows the display unit to end the pop-up display.

14. The display input device according to claim 13, wherein in a state of allowing the display unit to perform the pop-up display, when the message control section determines that a notification condition of displaying the message in the pop-up display is released, the display control section allows the display unit to end the pop-up display even if the end time has not yet elapsed.

15. The display input device according to claim 11, wherein when the user performs a predetermined replacement operation, the determination section determines that the display reset is performed.

16. An image forming device comprising:
the display input device according to claim 1; and
an image forming unit configured to form an image on a recording medium.
